(19) United States
(12) Patent Application Publication
(10) Pub. No.: US 2002/0023353 A1
(43) Pub. Date: Feb. 28, 2002

(54) Surgical scissors

(76) Inventor: Wu. Ting-Kung, Taipei Shuan (TW)

Correspondence Address: PRO-TECHTOR INTERNATIONAL, 20775 Norada Court, Saratoga, CA, 95070-3018, US

(21) Appl. No.: 09/982,444

(22) Filed: Oct. 17, 2001

Related U.S. Application Data
(63) Continuation-in-part of application No. 09/589,031, filed on Jun. 6, 2000.

(51) Int. Cl. B26B 13/00

(52) U.S. Cl. 30/124; 30/254

(57) ABSTRACT

An improved pair of scissors for cutting stitches in a suture or medical procedure comprises a non-metallic upper body having a front end integrally formed with a longitudinal through-slot which has inner and outer side wall faces, and a recess formed and positioned at the lower portion of the front end of said inner and outer side wall faces; a metal-made upper blade attached onto a major wall surface of said upper body, said upper blade further being engaged and attached onto said inner wall face; a non-metallic lower body having a major wall surface; and a metal-made lower blade attached to said major wall surface of said lower body, the front end of said lower blade having a curved blade portion which passes through said recess in said upper body to facilitate entry of said curved blade portion into said recess in said upper body.

This application is a continuation-in-part application of U.S. patent application Ser. No. 09/589,031, filed on Jun. 06, 2000.

### BACKGROUND OF THE INVENTION

1. Field of the Invention

The present invention relates to an improvement on a pair of scissors for cutting stitches in a surgical procedure, in particular one which is capable of clamping the cut thread of the stitches in a suture.

2. Description of the Related Art

FIGS. 8 show the structure of a pair of conventional surgical scissors disclosed in British patent no. GB 2350080, in which a sleeve (g) is provided at the free end of the upper blade (c). A clamping groove (h) is formed between the sleeve (g) and the upper blade (c) for guiding the entrance of an arcuate blade (f) for cutting the thread in stitched suture and clamping the cut thread. However, because the depth of the clamping groove (h) is not sufficient, the clamped cut thread could easily fall off therefrom and thus, the clamping effect of such surgical scissors is poor.

FIGS. 9 show the structure of another pair of conventional surgical scissors. However, such scissors have the disadvantage that the height of the clamping groove of the support base (o) cannot be easily controlled in the manufacturing process so that the gap distance between the arcuate blade (n) and the clamping groove easily becomes varied and, consequently, the cut thread of the suture likewise cannot be efficiently clamped. In addition, the length of the cut thread clamped by this pair of scissors is so short that it could easily fall off.

Furthermore, another drawback of the above-mentioned conventional scissors is that the scissors formed from stainless steel or aluminum alloy are discarded after use, thereby causing waste of material.

### SUMMARY OF THE INVENTION

A main object of the present invention is to provide an improved pair of surgical scissors consisting of an upper and a lower blade body made of metal and an upper and a lower main body made of plastic, thus lowering the overall cost of material in the production of the scissors.

Another object of the present invention is to provide an improved pair of surgical scissors used in medical procedures, in which a recess is formed at the lower portion of the inner and outer side walls at the front end of the main body for allowing the lower blade to enter, at a large arcuate angle, into the through-slot and to make a longer distance of cutting movement with the upper blade, so that threads of different outer diameters can be effectively cut and fine threads can be effectively clamped as well.

Accordingly, the present invention provides an improved pair of scissors for cutting stitches in a suture or medical procedure, comprising a non-metallic upper body having a front end integrally formed with a longitudinal through-slot which has inner and outer side wall faces, and a recess formed and positioned at the lower portion of the front end of said inner and outer side wall faces; a metal-made upper blade attached onto a major wall surface of said upper body, said upper blade further being engaged and attached onto said inner wall surface; a non-metallic lower body having a major wall surface; and a metal-made lower blade attached to said major wall surface of said lower body, the front end of said lower blade having a curved blade portion which passes through said recess in said upper body to facilitate entry of said curved blade portion into said recess in said upper body at a large degree of arc.

### BRIEF DESCRIPTION OF THE DRAWINGS

Other features and advantages of the present invention will become apparent in the following detailed description of a preferred embodiment with reference to the accompanying drawings, in which:

FIG. 1 is a perspective view of the present invention;

FIG. 2 is an exploded, perspective view showing some parts of the present invention;

FIG. 3 is an exploded, perspective view showing the detailed parts of the present invention;

FIG. 4 is a side operational view showing the lower blade attached to the lower body of the present invention;

FIG. 5 is a plan view showing the lower blade of the present invention hooking a thread;

FIG. 6A is a plan view showing the lower and upper blades of the present invention in a position prior to the cutting operation;

FIG. 6B is a plan view showing the lower and upper blades of the present invention in a position after the cutting operation and clamping the thread;

FIG. 6C is an enlarged plan view of a part taken from FIGS. 6A and 6B;

FIG. 7A is a sectional view showing the upper and lower blades of the present invention in a position prior to the cutting operation;

FIG. 7B is a sectional view showing the upper and lower blades of the present invention as they commenced with the cutting operation;

FIG. 7C is a sectional view showing the upper and lower blades of the present invention after the cutting operation; and

FIG. 7D is a sectional view showing the cutting and clamping operation of the present invention directed to a thread having a finer outer diameter.

FIG. 8 shows a perspective view of a conventional scissors.

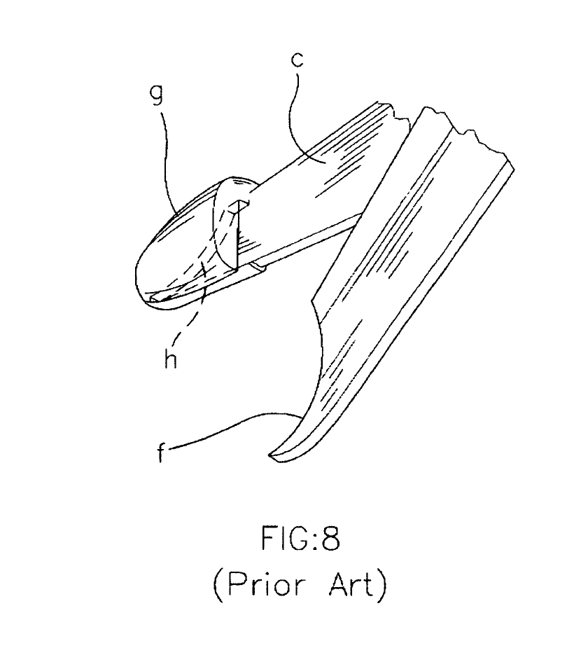

FIG. 9 shows a perspective view of another conventional scissors.

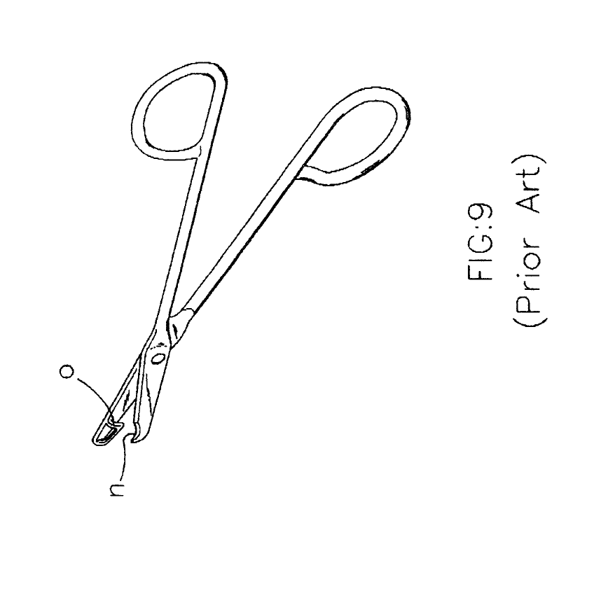

### DETAILED DESCRIPTION OF THE PREFERRED EMBODIMENT

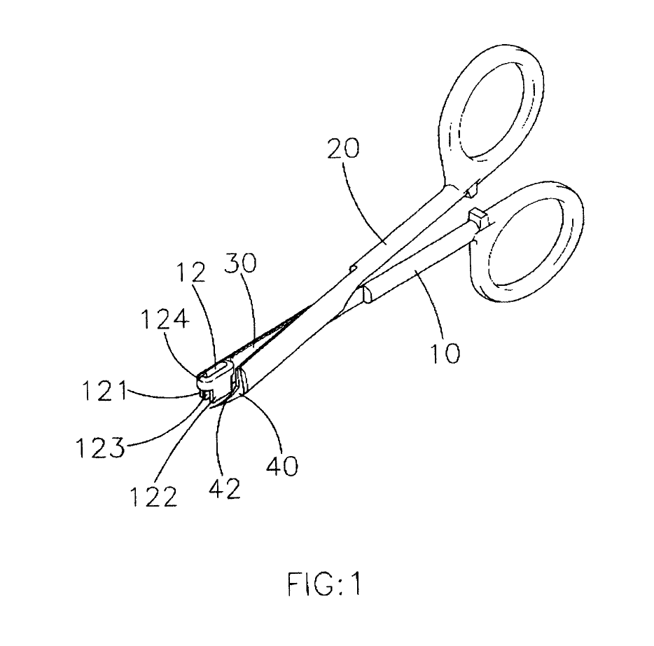

A preferred embodiment of the present invention will now be described with reference to FIGS. 1, 2, 3 and 4, which show the structure of the present invention as comprising a non-metallic upper body 10 having a front end integrally formed with a longitudinal through-slot 12, the longitudinal slot 12 having inner and outer side wall faces 121, 122, and a recess 123 formed and positioned at the lower portion of the front end of the inner and outer side wall faces 121, 122; a metal-made upper blade 30 which may be attached onto the major wall surface 14 of the upper body 10, the upper blade 30 further being engaged and attached onto the inner wall surface 121; and a non-metallic lower body 20 having a major wall surface 24 which engages a metal-made lower blade 40 in such a manner that the lower blade 40 is attached to the major wall surface 24, the front end of the lower blade 40 having a curved blade portion 42 which passes through the recess 123, the curved shape facilitating entry of the blade portion 42 into the recess 123 at a large degree of arc.

According to the above-described features, an engaging groove 124 is provided at the front end of the slot 12 on the upper surface of the slot wall. The front end of the upper blade 30 is provided with a positioning strip 31, the rear of the positioning strip 31 being formed into a U-shaped groove 33, and the rear end of the upper blade 30 being formed with a semi-circular notch 34 (or a rounded hole). A pivot hole 141 is provided on the major wall surface 14 of the upper body 10. The major wall surface 24 of the lower body 20 is integrally formed with a pivot shaft 241 and an inner through-hole 242.

A projection 43 is punched out of the side wall surface of the metal-made lower blade 40 for insertion into the through-hole 242, and a semi-circular notch 44 (or a rounded hole) is provided at the terminal end of the lower blade 40 for corresponding engagement with the engaging shaft 241. The positioning strip 31 of the upper blade 30 engages with the engaging groove 124, and the semi-circular notch 34 is in register (and engages) with the engaging shaft 241, the engaging shaft 241 being then inserted into the pivot hole 141 of the upper body 10.

According to the above-described features, the engaging shaft 241 has an end portion in the form of a barb 243 with a longitudinal channel 244. The barb 243, which is of a greater diameter, is in the contracted state when inserted into the pivot hole 141, so that the barb 243 can pass through pivot hole 141, after which the barb is restored to its original position, thereby achieving the assembly of the upper and lower bodies 10,20 and the upper and lower blades 30, 40, forming a pair of scissors.

According to the above-described features, the blade portion 32 extends out of the lower end of the inner side wall surface 121 of the upper body 10.

According to the above-described features, the upper and lower main bodies 10, 20 are integrally formed from plastic.

According to the achievement of the above-described primary and secondary features, the embodiments of the present invention in practice are as follows:

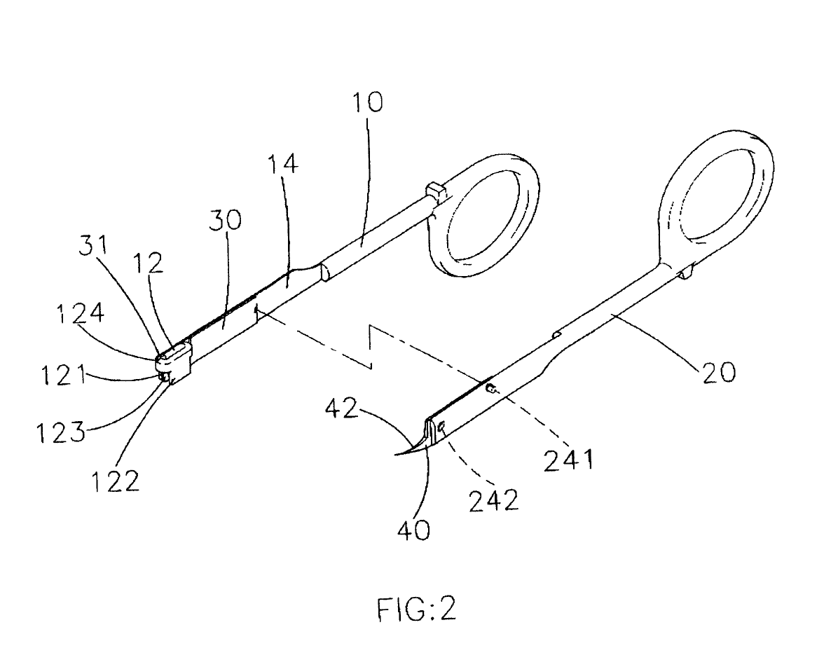

As shown in FIGS. 1 and 2, since the upper body 10 and lower body 20 are both injection-molded from plastic material, whereas the upper blade 30 and lower blade 40 are made of stainless steel (or other metals), and the metal-made upper and lower blades 30, 40 only occupies a portion of the entire scissors, the cost in terms of the expensive metal material can thus be extensively minimized.

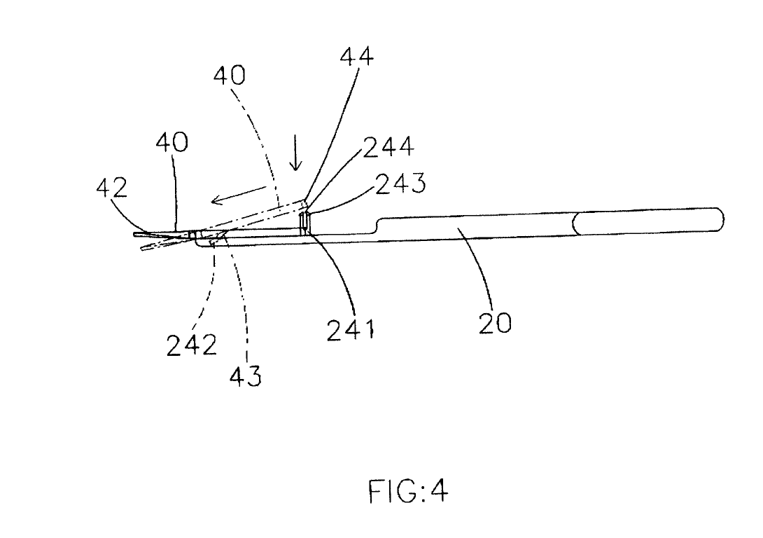

As shown in FIG. 4, the engaging shaft 241 and the inner through-hole 242 may be integrally formed on the lower body 20, and thus, the projection 43 may be inserted through and into the through-hole 242, with the semi-circular notch 44 in registry with the engaging shaft 241. In addition, the positioning strip 31 on the upper blade 30 may be hooked into the engaging groove 124, and the semi-circular notch aligns (and engages) with the engaging shaft 241. Then the barb 243 at the front end of the engaging shaft 241 is inserted into the through-hole 141 in the upper body 10, so that the lower blade 40 is stably positioned on the major wall surface 24 of the lower body 20, and the upper blade 30 is stably positioned on the major wall surface 14 of the upper body 10. When the upper and lower blades 30, 40 are in a cutting motion, a close rotation is achieved with the engaging shaft 241 acting as the center of rotation.

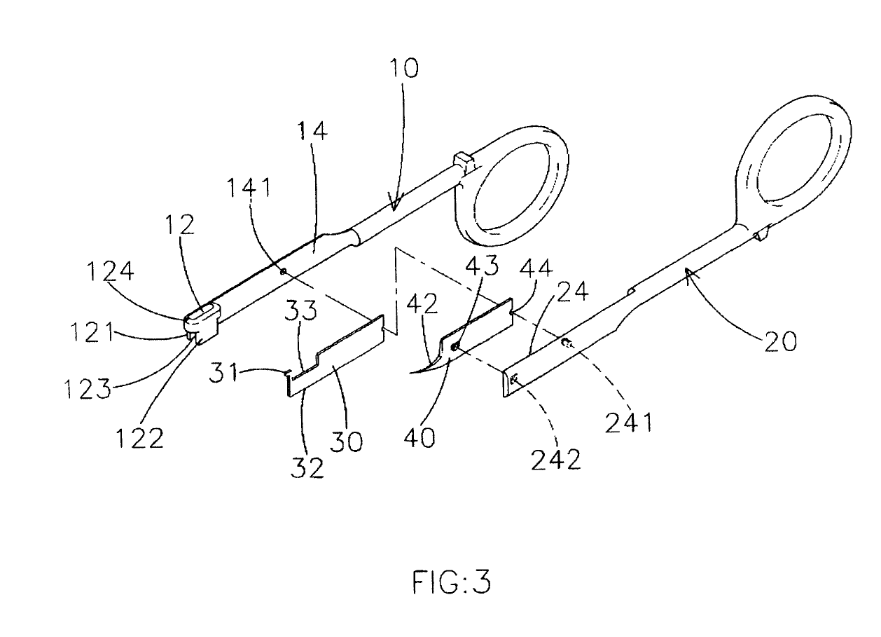

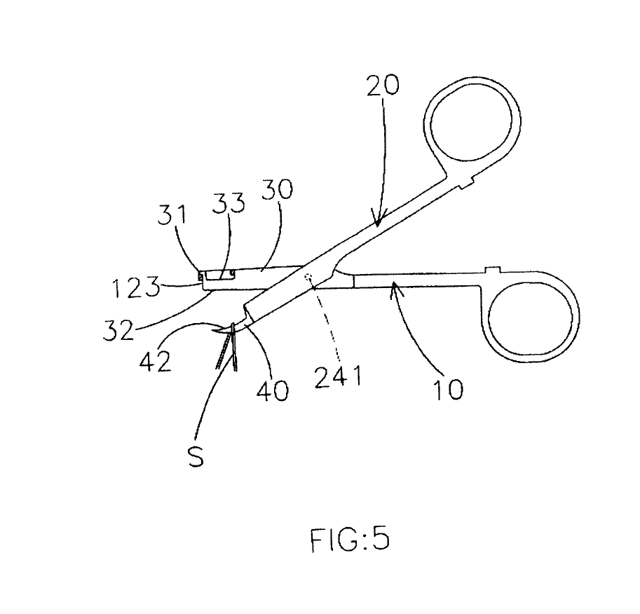

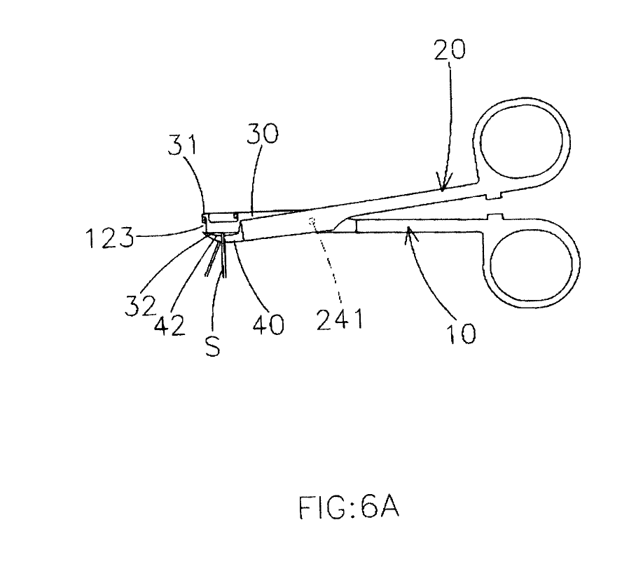

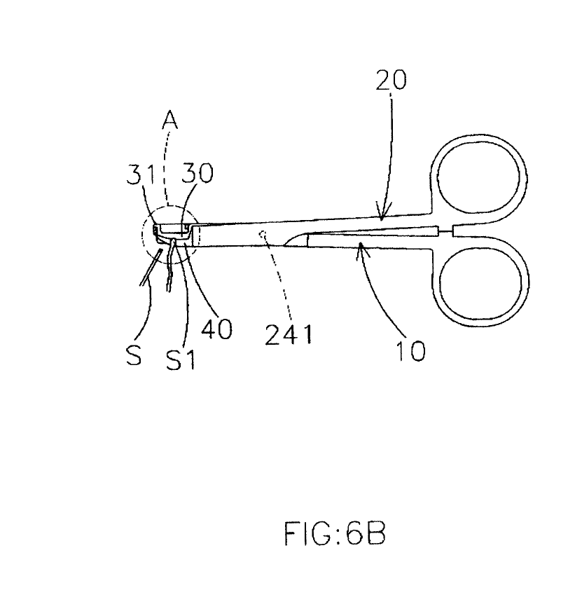

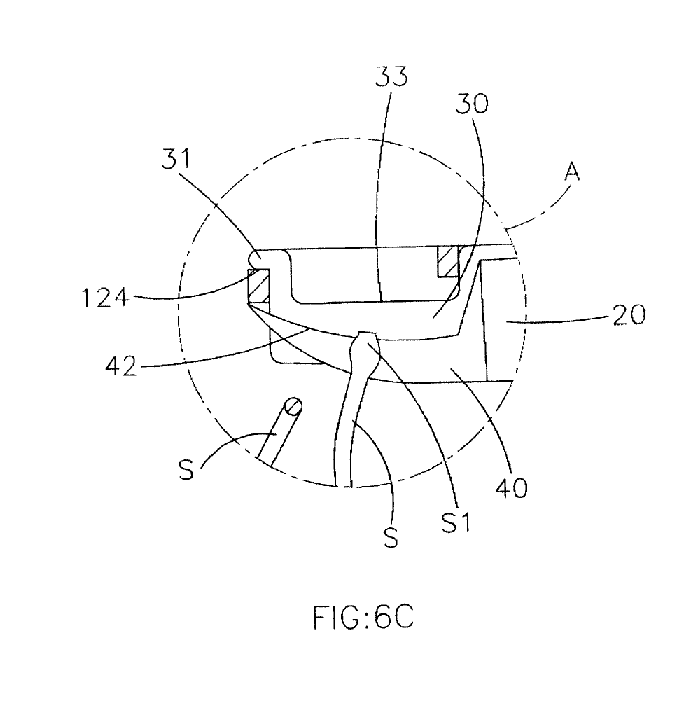

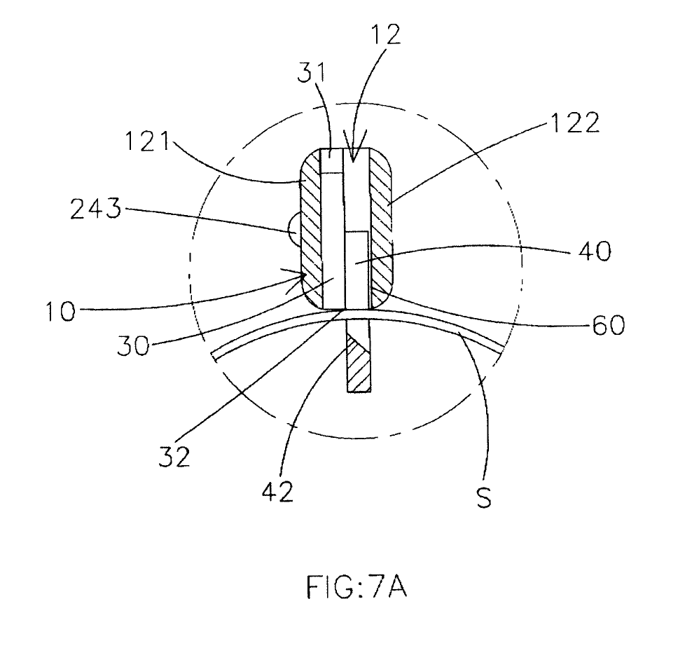

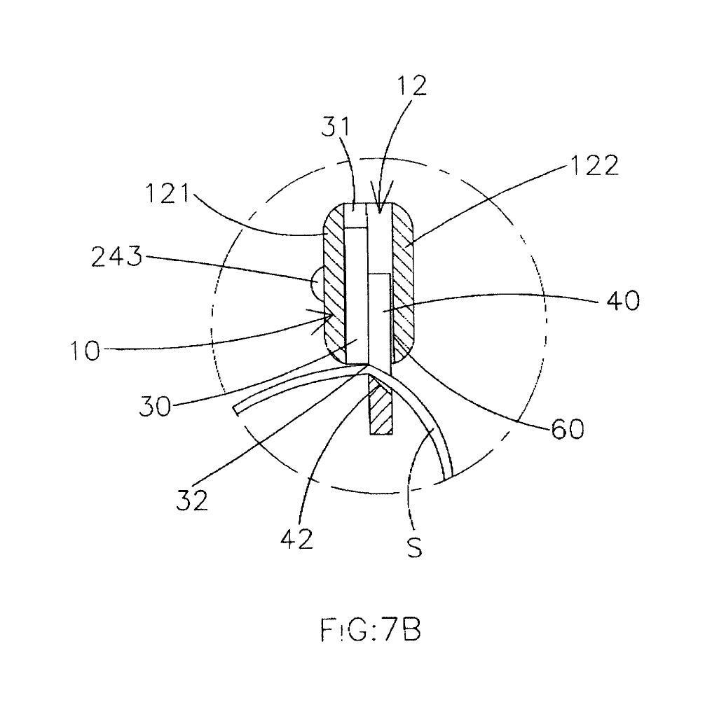

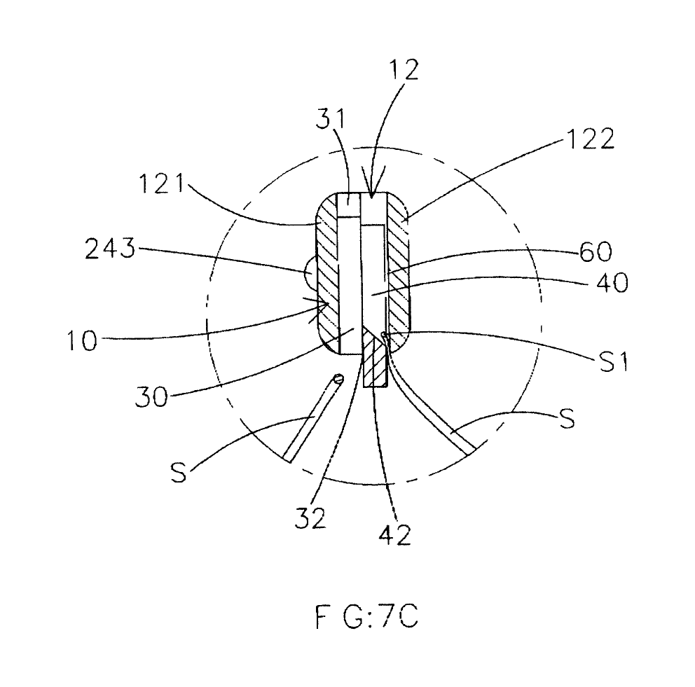

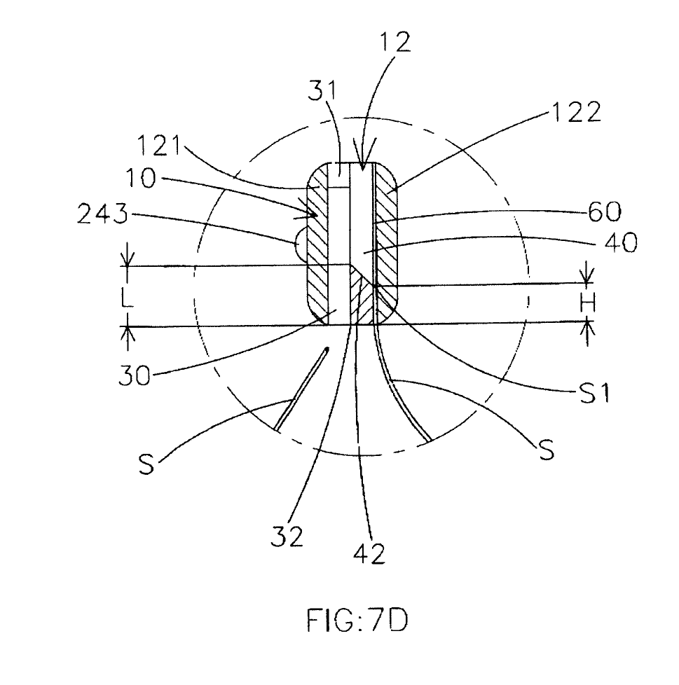

The recess 123, shown in FIGS. 2 and 3, enables the blade portion 42 of the lower blade 40 to effectively, and in a wide arcuate angle, enter into the through-slot 12, so that the blade portions 32, 42 of the upper and lower blades 30, 40, respectively, achieve an effective closeness. In operation, as shown in FIG. 5, the lower blade 42 hooks the thread S and, subsequently, as shown in FIG. 6A, the lower blade 40 is just entering into the notch 121. FIG. 6B shows the thread S being cut by the upper and lower blade portions 32, 42. Further, in FIGS. 7A, 7B and 7C, the clearance 60 shown therein consists of the distance between the outer side wall surface 122 and the lower blade 40. Upon cutting of the thread S, the cut end S1 is clamped in the clearance 60 (as shown in FIG. 7C), thus achieving the clamping of the thread.

Due to the design of the recess 123, the entrance of the lower blade portion 42 into the through-slot 12 is enlarged in distance. At this point a significant effect is achieved. As shown in FIG. 7D, the outer diameter of the thread S is finer. Thus, the area of the length L of the close cutting of the blade portions 32, 42 is increased, and correspondingly, the height H of the acting clearance 60 of the clamped thread end S1 is increased. Thus, a less fine thread S can also be effectively cut and clamped.

In view of the foregoing, the effects and objects intended to be achieved by the features of the present invention indeed can undoubtedly be accomplished. The applicant thus filed a patent application for the present invention.

It will be understood that the present invention may be embodied in other specific forms without departing from the spirit or central characteristics thereof. The present examples and embodiments, therefore, are to be considered in all respects as illustrative and not restrictive, and the present invention is not to be limited to the details given herein.

What is claimed is:

1. An improved pair of surgical scissors comprising:
a non-metallic upper body having a front end integrally formed with a longitudinal through-slot which has inner and outer side wall faces, and a recess formed and positioned at the lower portion of the front end of said inner and outer side wall faces;
a metal-made upper blade attached onto the surface of said upper body, said upper blade further being engaged and attached onto said inner wall face;
a non-metallic lower body having a major wall surface; and
a metal-made lower blade attached to said major wall surface of said lower body, the front end of said lower blade having a curved blade portion which passes through said recess in said upper body to facilitate entry of said curved blade portion into said recess in said upper body.

2. A surgical scissors as claimed in claim 1, wherein an engaging groove is provided at the front end of said though-slot on the upper surface of the slot wall, and the front end of said upper blade is provided with a positioning strip, the rear of said positioning strip being formed into a U-shaped groove, and the rear end of the upper blade being formed with a semi-circular notch (or a rounded hole); wherein a pivot hole is provided on said major wall surface of said upper; wherein said major wall surface of said lower body is integrally formed with a pivot shaft and an inner through-hole; wherein, a projection is punched out of the side wall surface of said lower blade for insertion into said inner through-hole, and a semi-circular notch (or a rounded hole) is provided at the terminal end of said lower blade for corresponding engagement with said engaging shaft; and wherein said positioning strip of said upper blade engages with said engaging groove, and said semi-circular notch on said upper blade is in register (and engages) with said engaging shaft, said engaging shaft being then inserted into said pivot hole on said upper body.

3. A surgical scissors as claimed in claim 1, wherein said engaging shaft has an end portion in the form of a barb with a longitudinal channel, said barb being of a greater diameter and being in the contracted state when inserted into said pivot hole, and said barb after passing through said pivot hole being restored to its original position, thereby achieving the assembly of said upper and lower bodies and said upper and lower blades, forming a pair of scissors.

4. The surgical scissors as claimed in claim 1, wherein said blade portion of said upper blade extends out of the lower end of said inner side wall face of said upper body.

5. A surgical scissors as claimed in claim 1, wherein said upper and lower bodies are integrally formed from plastic.
